(19) United States
(12) Patent Application Publication
(10) Pub. No.: US 2011/0029523 A1
(43) Pub. Date: Feb. 3, 2011

(54) Identifying a test set of target objects

(76) Inventors: Flor A. Castillo, Lake Jackson, TX (US); Jeffrey D. Sweeney, Midland, MI (US)

Correspondence Address: The Dow Chemical Company;Brooks, Cameron, PLLC, 1221 Nicollet Avenue, Suite 500, Minneapolis, MN, 55403, US

(21) Appl. No.: 12/590,869

(22) Filed: Nov. 16, 2009

Related U.S. Application Data
(60) Provisional application No. 61/199,644, filed on Nov. 19, 2008.

(51) Int. Cl. G06F 17/30

(52) U.S. Cl. 707/737; 707/E17.089

(57) ABSTRACT

Methods and structures having and/or implementing integrated steps for use in a planning phase of experimentation, which can allow the researcher to explore the experimental space while reducing the number experiments performed.

This application claims priority from U.S. Provisional Application Ser. No. 61/199,644 filed Nov. 19, 2008, the entire content of which is incorporated herein by reference.

### FIELD OF THE INVENTION

Embodiments of the present disclosure are directed toward a planning stage of experimentation; more specifically, embodiments of the present disclosure include methods and devices which use the principle of statistical clustering to reduce a number of experiments during high throughput research.

### BACKGROUND

High throughput research, also referred to as high throughput experimentation, is an increasingly important tool for the development of new compounds. High throughput research can be thought of as an application of various high throughput techniques, such as combinatorial chemistry or high throughput screening, in conjunction with various instrumentations, such as robotics and software platforms. The practice of high throughput research can lead to the development of new compounds that can include catalysts, polymers, electronic materials, and biomaterials.

As with other industries, demands for higher productivity, lower costs, and greater development speeds continue to drive the search for new technologies, methods, and systems in high throughput research.

High throughput research can be divided into three distinct phases, the planning phase, the execution phase, and the analysis phase. Some contributions to the art have been made in the execution and analysis phases of high throughput research.

A number of variables can be encountered during high throughput research. In addition, the variables may have many levels. Although it can be important to explore all variables, experimenting in all levels can increase the cost and/or number of experimental runs needed to explore all levels. One challenge associated with high throughput research is selecting the levels to be studied without losing key information.

### SUMMARY

Embodiments of the present disclosure include methods and devices having and/or implementing integrated steps which can select a test set of target objects for experimentation. As discussed herein, embodiments of a method for selecting a test set of target objects for experimentation include selecting a number of target objects for experimentation, identifying a number of variables for each of the number of target objects, and performing a cluster analysis on the number of variables for each of the number of target objects to group the number of target objects into clusters of target objects with similar variables. For the various embodiments, the method also includes determining a number of optimal clusters of target objects and selecting a representative target object from each of the optimal clusters of target objects to form a test set of target objects.

In some embodiments, the method includes performing an experiment on the test set of target objects. In some embodiments, the method further includes identifying a further test representative target object, determining the cluster from which the further test representative target object originates, and performing an additional experiment on the cluster from which the further test representative target object originates.

Embodiments of the present disclosure include a network device including a processor, a memory subsystem in communication with the processor, and computer executable instructions stored in the memory subsystem and executable by the processor to receive input identifying a number of target objects and a number of variables for each of the number of target objects, perform a cluster analysis on the variables of the target object to group the number of target objects into clusters of target objects with similar variables, determine a number of optimal clusters, and select a representative target object from each optimal cluster of target objects to form a test set of target objects to be utilized for experimentation.

Embodiments of the present disclosure include a computer readable medium having instructions stored thereon for causing a computing device to perform a method including receiving input identifying a number of target objects and a number of variables for each of the number of target objects, performing a cluster analysis on the variables of the target object to group the number of target objects into clusters of target objects with similar variables, and selecting a representative target object from each optimal cluster of target objects to form a test set of target objects.

The above summary of the present disclosure is not intended to describe each disclosed embodiment or every implementation of the present disclosure. The description that follows more particularly exemplifies illustrative embodiments. In the application, guidance is provided through examples, which can be used in various combinations. In each instance, the recited examples serve only as a representation and should not be interpreted as exclusive.

### DEFINITIONS

As used herein, “a,” “an,” “the,” “at least one,” and “one or more” are used interchangeably. The terms “includes” and “comprises” and variations thereof do not have a limiting meaning where these terms appear in the description and claims. Thus, for example, when identifying a number of variables, “a” number of variables can be interpreted to mean that there may be “one or more” variables.

The term “and/or” means one, one or more, or all of the listed elements.

As used herein, the term “chemical property” is a characteristic of a substance that becomes known during a chemical reaction; also, a “chemical property” can refer to a property used to characterize a substance in reactions that change the substance.

The term “experimental region” or “experimental space” refers to all possible experiments to test the variables of the target object.

The term “further test representative target object” is a representative target object of the test set that produces results that are determined to be of value to the researcher.

The term “high throughput research” can include a combination of machines, robots, hardware, software, laboratory accessories, experimental accessories, and persons that can perform and experiment on a “target object.”

The term “multiple dimensions” refers to the set of variables that describe each target object.

The term “physical property” is any property used to characterize matter and energy and their interactions. The “physical property” can be an aspect of an object or substance that can be measured or perceived without changing the substance.

The term “similar variables” is used with respect to a part of the clustering process where at each subsequent step of clustering the target objects the clustering process calculates the distance (e.g. difference) between the variables contained within each cluster and combines those clusters that are the closest together (e.g. most similar). Therefore, the clusters with the smallest distance between the variables are combined into an individual cluster because they have “similar variables”.

The term “target object” refers to a substance identified by a variable that is combined, mixed, or processed in experimentation.

The term “variable” refers to a property or characteristic of a target object that uniquely distinguishes the target object from other target objects, including “discrete variables” which refer to a variable that has one or more categories with no distinct order among the categories, for example: a type of compound.

### BRIEF DESCRIPTION OF THE DRAWINGS

FIG. 1 illustrates a flow diagram utilizing a statistical technique cluster analysis to design an experiment for an experimentation in accordance with one or more embodiments of the present disclosure.

FIG. 2 illustrates a computer system that includes a computer readable medium and network device suitable to perform experimentation in accordance with one or more embodiments of the present disclosure.

FIG. 3 illustrates a dendrogram diagram and a scree plot of cluster analysis for variables of a Polyol formulation in accordance with one or more embodiments of the present disclosure.

FIG. 4 illustrates a dendrogram diagram and a scree plot of cluster analysis of products based on a number of variables in accordance with one or more embodiments of the present disclosure.

FIG. 5 illustrates a dendrogram diagram and a scree plot of cluster analysis of products based on a number of variables in accordance with one or more embodiments of the present disclosure.

### DETAILED DESCRIPTION

The present disclosure provides embodiments that include a systematic method for reducing the number of experiments in experimentation that can include, but is not limited to, high throughput research in the presence of variables.

High throughput research can include using robotics, data processing and control software, liquid handling devices, and detectors to allow the researcher to quickly conduct a large number of experiments. High throughput research can be a valuable tool because it can allow the researcher to screen numerous substances, herein described as “target objects,” and identify specific activity or behavior of the substances. In addition, the information received from performing a high throughput screening experiment may provide the starting point for drug design and/or for understanding the interaction and/or role of a particular substance.

During experimentation, variables may be encountered. These variables can have a large number of levels. For example, if a researcher is experimenting with Polyol, the researcher may want to look at all different levels of the group Polyol. Beyond the different levels, it can also be beneficial to experiment with different concentrations of the Polyol and various other additives. Therefore, to be able to experiment in the entire experimental space, the number of experimental runs may significantly increase with each new variable introduced, along with each level of the variable. As such, experimenting with more variables may increase the number of experimental runs in order to explore the entire experimental space and may significantly increase the time and cost of the experimentation.

Some previous approaches taken with regard to experimentation allow for research judgment and can permit the researcher to randomly select the levels of the variables to study. However, this type of methodology can increase the risk that various variables will not be tested, which can result in an entire experimental space not being tested causing information to be missed and/or overlooked. Another approach taken with regard to experimentation has been to test all variables, which can increase the time required and cost for the research. In contrast, embodiments of the present disclosure apply a clustering analysis to variables that distinguish a target object from other target objects before the experiment is planned and executed to allow the researcher to reduce the number of target objects that are initially studied without losing information. This methodology can reduce the number of experiments performed to explore the experimental space from about 20 percent to about 60 percent. The test set of target objects is about 25 to about 60 percent smaller than the number of variables for each of the number of target objects originally identified. This reduces the number of experiments to explore the experimental space. Additionally, the test set of target objects is at least 50 percent smaller than the number of variables for each of the number of target objects. Therefore, methods of the present disclosure systematically explore the experimental region and reduce the number of experimental runs by selecting a test set of target objects with a select set of variables to be investigated; thus maximizing information while minimizing experimentation cost and time.

The various embodiments include methods of clustering a number of target objects to reduce the number of experiments while still allowing the researcher to explore the entire experimental space during experimentation. Although the examples and preferred embodiments are focused towards target objects of high throughput research and preferably towards experimentation where the number of target objects is equal to or greater than ten, these methods can be used for the design of other experiments. For example, the methods can be used to screen among a large set of candidates (i.e. catalysts) and/or for post analysis of an already screened set of candidates.

The Figures herein follow a numbering convention in which the first digit or digits correspond to the drawing Figure number and the remaining digits identify an element or component in the drawing. As will be appreciated, elements shown in the various embodiments herein may be added, exchanged, and/or eliminated to provide any number of additional embodiments.

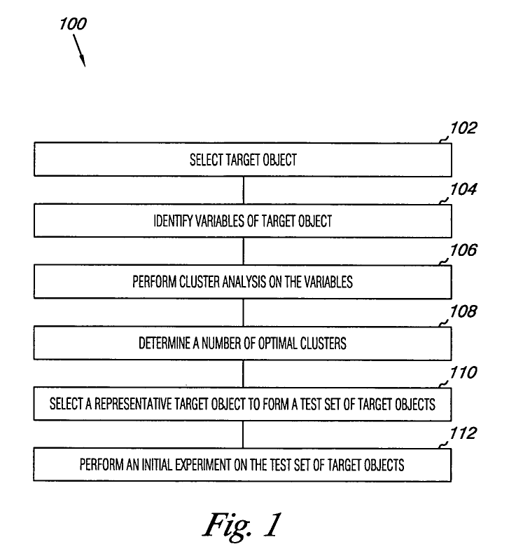

FIG. 1 illustrates a flow diagram utilizing a statistical technique cluster analysis to design an experiment for experimentation, in accordance with one or more embodiments of the present disclosure.

At block 102, the method 100 includes selecting target objects to be studied in experimentation. Selecting the group of target objects can vary from experiment to experiment as the researcher can determine which target objects are studied for various experiments. As will be appreciated by one skilled in the art, there are many types of experimental designs that can require a large number of experimental trials to be performed, and embodiments of the present disclosure can include the use of many types of experimental design. In one or more embodiments, the preferred number of target objects to be studied in experimentation is equal to or greater than ten.

In various embodiments, and as illustrated at block 104, the method 100 also includes identifying variables of the target objects once the target object has been identified. As can be appreciated by one skilled in the art, the variables identified may vary depending on the target object chosen and the researcher's purpose for experimenting with that particular target object. The target objects can include a main substance including its various levels, concentrations, additives, and non-numerical properties. Furthermore, the variables to be used in the cluster analysis may include the physical and chemical properties of the target object.

For example, various types of physical properties can include, but are not limited to, absorption, acceleration, area, capacitance, concentration, conductance, density, dielectric constant, displacement, ductility, distribution, efficacy, electric charge, electric current, electric field, electric potential, emission, energy, expansion, exposure, fluidity, frequency, mass, molality, temperature, thermal transfer, time, molecular weight, and viscosity.

Furthermore, various types of chemical properties can include, but are not limited to, electronegativity, ionization potential, pH balance, reactivity against other chemical substances, heat of combustion, enthalpy of formation, toxicity, chemical stability in a given environment, flammability, preferred oxidation state(s), coordination number, capability to undergo a certain set of transformations (e.g. molecular dissociation), chemical combination, redox reactions under certain physical conditions in the presence of another chemical substance, and preferred types of bonds to form (e.g., metallic), ionic, covalent.

As illustrated at block 106, the method 100 includes performing a cluster analysis on the variables of the target object. Clustering is a technique of grouping objects together that share similar values across a number of variables. As will be appreciated to those skilled in the art, the clustering analysis can be performed by the JMP® software, available from SAS Institute, Cary, N.C. It should also be appreciated that other computer programs capable of performing cluster analysis or programs that utilize an algorithm to group sets of data may be used within the scope of embodiments of this disclosure. Furthermore, as one skilled in the art shall appreciate, the cluster analysis may also be performed by hand.

There are many types of clustering analysis techniques. For example, clustering analysis can be performed by hierarchical cluster analysis, non-hierarchical cluster analysis, a neural network, a self-organizing map, k-means clustering, and Jarvis-Patrick clustering.

In one or more embodiments, performing a hierarchical cluster analysis can be used as the basis for the algorithm to cluster the target objects. The cluster analysis technique starts with each target object as its own cluster. At each subsequent step the clustering process calculates the distance between each cluster and combines the two clusters that are closest together (e.g. most similar). The process of clustering continues until all of the target objects have been combined into one single cluster.

In one or more embodiments, the clustering process steps are portrayed in the output as a dendrogram graph or tree diagram. The dendrogram graph can be used to illustrate the clusters formed from the cluster analysis. The dendrogram graph is a tree diagram that lists each target object and shows which cluster each target object is in and when it entered each particular cluster. The left side of the dendrogram graph lists all of the target objects in their own cluster, moving towards the right side of the dendrogram graph the target objects begin to cluster together. Eventually, at the far right side of the dendrogram graph, all of the target objects are grouped together into one final cluster.

In one or more embodiments, in addition to the dendrogram graph, a “scree” plot may be generated from the cluster analysis and is positioned below the dendrogram graph. As one skilled in the art can appreciate, the scree plot is a plot of the distances between each of the clusters of target objects and has a point for each combining of clusters. The scree plot can be generated by software or by hand.

In various embodiments, as illustrated at block 108, the method 100 can include determining an optimal number of clusters. After the dendrogram graph is generated, the researcher can interpret the dendrogram graph to determine the optimal number of clusters formed. As discussed above, one side of the dendrogram graph has all the individual target objects in separate clusters and the other side has all the target object in one cluster. At some intermediate point, there is an optimal number of clusters.

One approach to determining the optimal number of clusters can be to rely on the experience and knowledge of the researcher performing the cluster analysis. As one skilled in the art can appreciate, researchers performing cluster analysis can be familiar with interpreting dendrogram graphs and base the determination of the optimal number of clusters off of their knowledge and skill in the art.

Another approach in determining the optimal number of clusters can be to rely on the generated scree plot. As discussed above, the scree plot has a point for each combination of clusters. The ordinate of the line shown on the scree plot is the distance that was bridged to join the clusters at each step. In some instances, there may be a natural break in the ordinate where the distance suddenly increases. This break may indicate to researchers the optimal number of clusters because the larger the ordinate, the more different all of the target objects are in one cluster. Therefore, the dendrogram graph, scree plot, and experience and knowledge of the researcher may be used separately or in combination to determine the optimal number of clusters. One skilled in the art can also appreciate that the computer software performing the cluster analysis may include a pre-programmed mathematical equation for determining the optimal number of clusters, where the experience and/or knowledge of the researcher would not be required to determine the optimal number of clusters. Furthermore, this mathematical calculation for determining how many optimal clusters may also be performed by hand.

As illustrated at block 110, the method 100 also includes selecting a representative target object from each optimal cluster of target objects to form a test set of target objects. The test set of target objects can be formed by comparing all of the target objects in each optimal cluster against each other based on multiple dimensions. If two or more target objects are similar, then only one is selected. The process is repeated for each optimal cluster of target objects until the most selective set of dissimilar target objects emerges. The representatives from each optimal cluster form the test set of target objects. Forming the test set of target objects can reduce the number of experiments performed to explore the experimental space by about 20 percent to about 60 percent. Additionally, the number of experiments performed to explore the experimental space can be reduced by at least 50 percent. As such, the test set of target objects can be in a range of about 20 percent to about 60 percent smaller than the variables of the target objects originally identified in block 104 of method 100. In other words, the clustering technique discussed herein can reduce the number of experiments to explore the experimental space by about 20 percent to about 60 percent. Additionally, the cluster analysis can reduce the number of experiments needed to explore the experimental space by at least 50 percent.

In various embodiments, as illustrated at block 112, the method 100 can include performing an initial experiment with the test set of target objects. The test set of target objects can be the set of target objects used for initial experimentation since they are an accurate representation of all the target objects in the experimental region. Experimenting with the test set reduces the number of experimental trials while maximizing the coverage across the target objects in terms of their chemical and/or physical characteristics. This method can be superior to other approaches of selecting at random a set of target objects for experimentation or completing all possible experiments using all of the target objects. As discussed herein, randomly selecting the test set can increase the risk of losing information since the experimental space may not be accurately represented within the test set. Furthermore, performing experimentation on the entire experimental space can increase the experimental cost and time involved. Therefore, embodiments of the method, as described herein, that use cluster analysis in the planning stages of the experiment to reduce the number of experiments while still exploring the entire experimental space maximizes the information obtained during the experiment while minimizing experimentation cost.

As discussed herein, the number of experiments to explore the entire experimental space can be reduced by a range of about 20 percent to about 60 percent by performing a cluster analysis on the variables of the target objects, determining an optimal number of clusters and selecting a representative target object to form a test set of target objects to be used for the initial experimentation. In the various embodiments, the number of experiments can be reduced by at least 50 percent.

In various embodiments, the researcher may analyze the data obtained from the initial experiments on the test set of target objects and identify which representative target object provides information and/or results that may be of interest for further experimentation. After determining the further test representative target object, the cluster from which that further test representative target object originated may be identified. Further experimentation may then be performed on members of the particular cluster from which the further test representative target object originated.

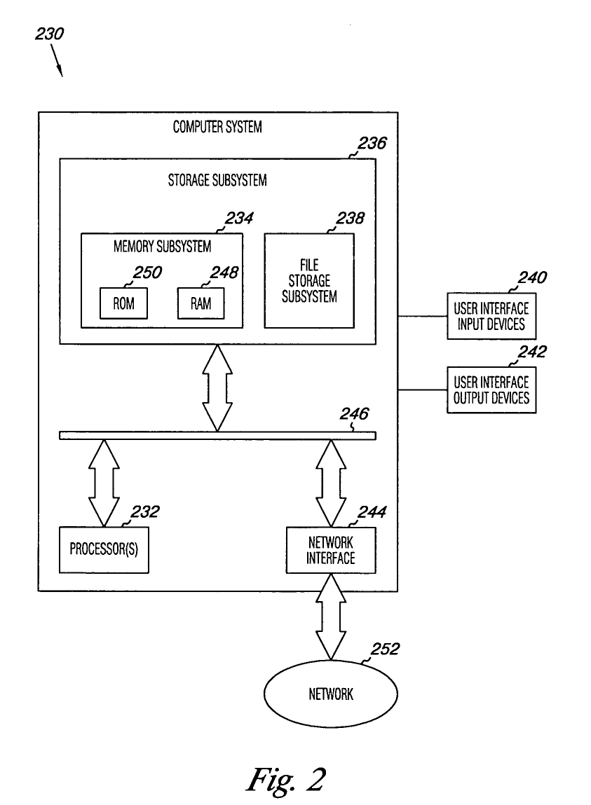

FIG. 2 illustrates a computer system that includes a computer readable medium and computing device suitable to perform experimentation in accordance with one or more embodiments of the present disclosure.

Various embodiments include a computing device which includes at least one processor 232 and a memory subsystem 234 which are in communication. Embodiments also include a processor 232 that communicates with a number of other components. For example, the other components may include a storage subsystem 236 having a memory subsystem 234 and a file storage subsystem 238, a configurable user interface input device 240 having a display, a configurable user interface output device 242 having a display, a network interface subsystem 244, and a communication bus 246. Embodiments described herein can be implemented in a distributed computing network environment and, as will be appreciated by one of ordinary skill in the art, the embodiments are not limited to the descriptions given herein.

The input and output devices 240, 242 can allow user interaction with the system 230, for instance, to provide for data entry or data retrieval. The storage subsystem 236 and/or the memory subsystem 234, as depicted by the computer system 230, can be in communication with known computing components to enable the system 230 to perform various functions, tasks, or roles, including steps of the method embodiments disclosed herein. For example, computer executable instructions can be stored in the memory subsystem 234, where stored instructions are executable by the processor 232 to receive input identifying a number of target objects and a number of variables for each of the number of target objects, perform a cluster analysis on the variables of the target object to group the number of target objects into clusters of target objects with similar variables, determine a number of optimal clusters, and select a representative target object from each optimal cluster to form a test set of target objects, as discussed herein.

The memory subsystem 234 can include, for example, programs, code, data, and/or look-up tables. A file storage subsystem 238 can provide storage for additional program and data files, and may include a hard disk drive, a floppy disk drive along with associated removable media, a compact digital read only memory (CD-ROM) drive, an optical drive, and/or removable media cartridges. The memory subsystem 234 can also include a number of memories including a main random access memory 248 (RAM) for storage of program instructions and data during program execution and a read only memory 250 (ROM) in which fixed instructions can be stored.

The file storage subsystem 238 can provide various computer readable medias. Embodiments of the present disclosure include a computer readable medium having instructions stored thereon for causing a computing device to perform a method to receive input defining a number of target objects and a number of variables for each of the number of target objects. Additionally, the computing device performs a cluster analysis on the variables of the target object to group the number of target objects into clusters of target objects with similar variables and determines an optimal number of clusters. Moreover, the computing device selects a representative target object from each optimal cluster of target objects to form a test set of target objects. Program embodiments can be included with the computer readable medium and may also be provided over a communications network such as the Internet, wireless RF networks, and/or other suitable network 252.

This disclosure is intended to cover adaptations or variations of various embodiments. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the disclosure includes other applications in which the above structures and methods are used.

### EXAMPLES

The following examples are provided to illustrate, but not to limit, the scope of the disclosure. Unless otherwise indicated, all instruments and all chemicals used are commercially available. These examples illustrate the use of cluster analysis to reduce the number of initial experiments that are performed, while exploring the entire experimental space, so that potential information is not overlooked.

### Example 1

This example describes a cluster analysis for variables of Polyol. The following variables of a Polyol formulation are 3 various concentrations of Polyol (0 weight percent, 2 weight percent, and 5 weight percent); 20 different types of Polyol, and 5 different types of additives.

To study the experimental space, the number of experimental trials involving all variables would require 300 different experiments, which includes all combinations of the concentrations, Polyol Types, and additives (3 concentrations×20 types of Polyol×5 additives=300 experiments).

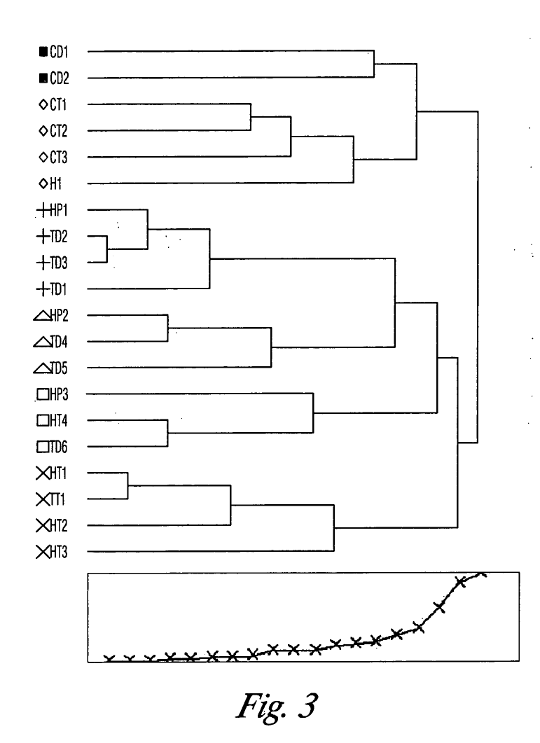

The chemical and/or physical characteristics associated with the Polyols (e.g., the target object), such as molecular weight, functionality, and oxide structure, among others, are gathered and a statistical clustering is performed using the hierarchical clustering analysis of the JMP® Statistical software. FIG. 3 is a dendrogram graph illustrating the groups of clusters formed from the clustering analysis and the scree plot illustrating the distances between each of the clusters of target objects is generated. The results are shown in FIG. 3 and each cluster is marked by a different symbol.

As illustrated in FIG. 3, Polyols CD1 and CD2 are defined within the same cluster, thus they are mathematically similar. Likewise, a second cluster is formed with Polyols CT1 and CT2. The process of combining clusters continues over all groups or objects. Once the cluster dendrogram graph and scree plot is produced, the optimal number of clusters is determined. The scree plot has a point for each combination of clusters, representing the distance between each of the clusters. Therefore, the scree plot and experience and knowledge of the researcher can be used to determine the optimal number of clusters

In this case, using both researcher knowledge and experience combined with an interpretation of the Scree plot, 11 Polyols are chosen from 6 clusters. Therefore, the number of experiments is reduced from the original 300 to 165 (3 concentrations×11 test set of target objects×5 additives=165). Performing the initial experiment on 165 target objects allows the time and cost of the experiment to decrease, while the experimental space is still explored.

After the initial screening experiments are performed, if one or more particular representative test set target objects (a type of Polyol) shows results that warrant additional experimentation, further test representative target objects within the same cluster of Polyols can be identified. Subsequently, the target objects of the cluster that the further test representative target object originated from can be further studied. This allows for further directed experimentation.

### Example 2

In this example, 66 types of Products are studied. In this case, the information of the Products includes the following 9 variables: 1) Length of a first compound, 2) Length of a second compound, 3) Length of a third compound, 4) Functionality, 5) Percent primary group, 6) Percent weight of the second group, 7) Percent weight of the first group, 8) Percent weight of the remaining, and 9) Equivalent weight.

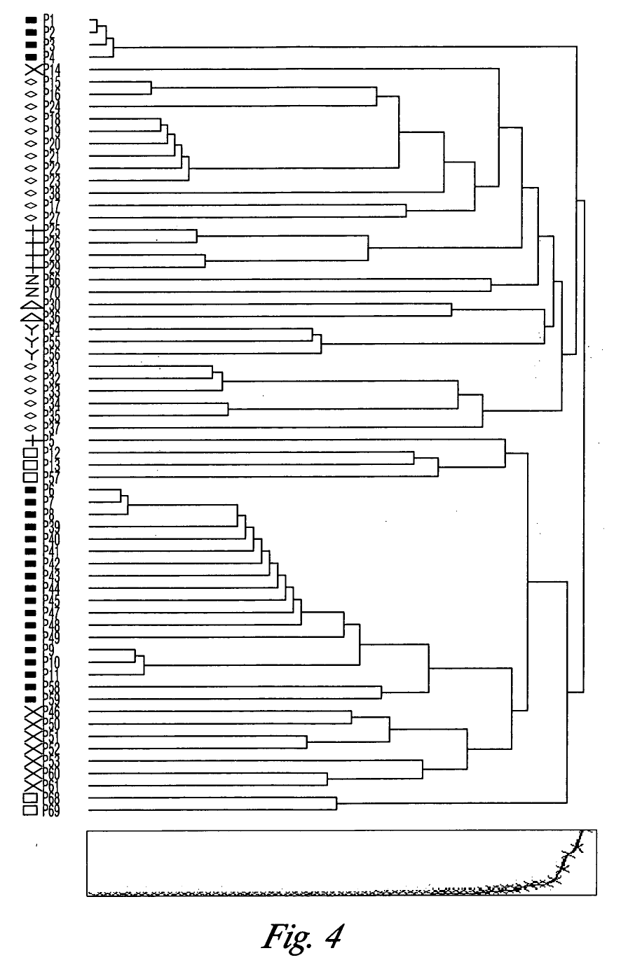

Statistical clustering of the Products is performed using the hierarchical clustering analysis of the JMP® Statistical software. The dendrogram graph and scree plot generated from the cluster analysis are illustrated in FIG. 4.

The pair of Products in the dendrogram graph whose branches are joined together at the same time are considered to be more alike. Thus, as an illustration from FIG. 4, Products P1 and P2 are similar when the 9 variables previously described are considered. Likewise, the following pairs are alike: P15 and P16, P18 and P19, P17 and P27, P25 and P26, P28 and P29, P66 and P70, P30 and P36, P54 and P55, P31 and P32, P34 and P35, P12 and P13, P6 and P7, P9 and P10, P58 and P59, P46 and P50, P51 and P52, P60 and P61, and P68 and P69.

A total of 19 pairs emerge to be similar products. In this case, only one of the pairs is experimented on rather than both. This reduces the number of experiments from 66 to 47. In this case, the 47 dissimilar objects consists of the 28 Products that did not get paired and the 19 chosen from the ones that did get paired. Likewise, the number of experiments is further reduced by noticing that P3 and P4 cluster at a very close distance with P1 and P2 and P8 clusters very close to P6 and P7. In the same way P20, P21, P22, and P23 cluster a very close distance and are very similar in the variables considered. Also, P39, P40, P41, P42, P43, P44, P45, P47, P48, cluster with P39 at a very close distance and, depending on the situation, only one can be selected. Considering this, the number of experiments can be further reduced by selecting representatives from the candidates that cluster at a close distance. In this case, the number of experiments is reduced to 32 (19 pairs and representatives from the items that cluster at close distance), thereby reducing the number of experiments by 52 percent while exploring the whole experimental space.

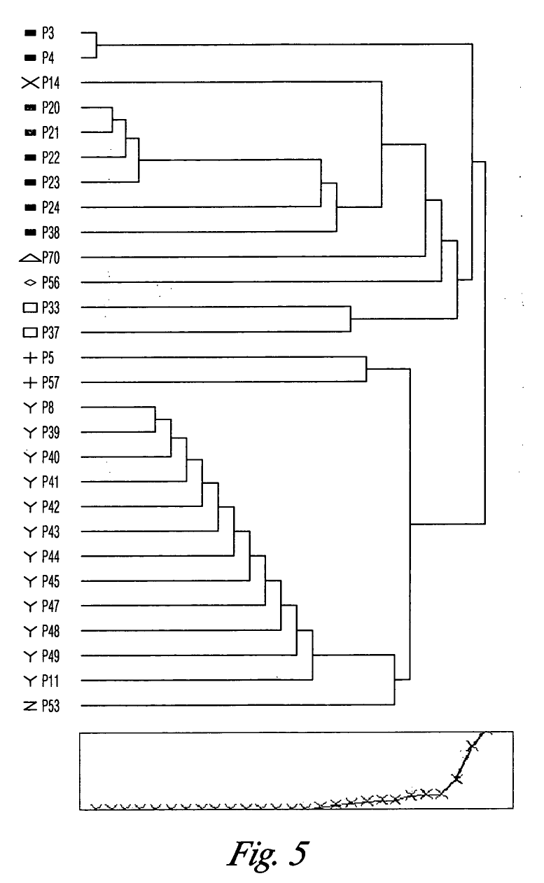

To further reduce the number experiments the cluster analysis can be repeated thereby eliminating the pairs already identified and paying close attention to the items that cluster at a close distance. The following dendrogram graph and scree plot is illustrated in FIG. 5.

From the dendrogram graph, the following pairs are identified: P3 and P4, P20 and P21, P33 and P37, P5 and P57, P8 and P9. Likewise, only one item from each of the 5 pairs is used for experimentation. P22 and P23 cluster at a very close distance with P20, P21. Also, P40, P41, P43, P44, P47, P48 cluster with P39 at a very close distance. Selecting representatives from the candidates that cluster at a close distance can further reduce the number of experiments.

The above example illustrates an efficient way of reducing the number of experiments when nominal variables are included. It also validates the idea of systematically reducing the number of experiments without losing significant information.

What is claimed is:

1. A method of selecting a test set of target objects for experimentation, the method comprising:
selecting a number of target objects for experimentation;
identifying a number of variables for each of the number of target objects, where the variables independently include properties of each of the number of target objects;
performing a cluster analysis on the number of variables for each of the number of target objects to group the number of target objects into clusters of target objects with similar variables;
determining a number of optimal clusters of target objects; and
selecting a representative target object from each of the optimal clusters of target objects to form a test set of target objects.

2. The method of claim 1, where the experimentation includes high throughput research.

3. The method of claim 1, where the test set of target objects is about 25 to about 60 percent smaller than the number of variables for each of the number of target objects.

4. The method of claim 3, where the test set of target objects is at least 50 percent smaller than the number of variables for each of the number of target objects.

5. The method of claim 1, where the number of variables for each of the number of target objects is chosen from at least one of a physical property and a chemical property of the target object.

6. The method of claim 1, where the cluster analysis is at least one of: hierarchical cluster analysis, non-hierarchical cluster analysis, a neural network, a self-organizing map, k-means clustering, and Jarvis-Patrick clustering.

7. The method of claim 6, where the cluster analysis is a hierarchical cluster analysis that is at least one of: agglomerative clustering, clustering with Pearson correlation coefficients, and divisive clustering.

8. The method of claim 7, where the agglomerative clustering uses at least one of: a nearest neighbor algorithm, a farthest-neighbor algorithm, an average linkage algorithm, a centroid algorithm, and a sum of squares algorithm.

9. The method of claim 1, where performing the cluster analysis on the number of variables includes reducing the clusters to the most dissimilar ones.

10. The method of claim 1, where performing the cluster analysis further includes displaying the clusters of target objects on a dendrogram graph.

11. The method of claim 1, where selecting the representative target object from each cluster of target objects includes comparing members of the clusters of target objects based on multiple dimensions.

12. The method of claim 11, where one variable is selected for the test set of target objects if two or more target objects are similar.

13. A network device, comprising:
a processor;
a memory subsystem in communication with the processor; and
computer executable instructions storable in the memory subsystem and executable by the processor to:
receive input identifying a number of target objects and a number of variables for each of the number of target objects;
perform a cluster analysis on the variables of the target object to group the number of target objects into clusters of target objects with similar variables;
determine a number of optimal clusters of target objects and
select a representative target object from each cluster of target objects to form a test set of target objects.

14. The network device of claim 13, where the test set of target objects is about 25 to about 60 percent smaller than the number of variables for each of the number of target objects.

15. The network device of claim 13, where the cluster analysis is at least one of: hierarchical cluster analysis, non-hierarchical cluster analysis, a neural network, a self-organizing map, k-means clustering, and Jarvis-Patrick clustering.

16. The network device of claim 13, where the network device is configured to compare a plurality of the number of variables and generate a hierarchical clustering dendrogram.

17. A computer readable medium having instructions stored thereon for causing a computing device to perform a method, the method comprising:
receiving a number of target objects for an experimentation;
receiving a number of variables for each of the number of target objects, where the variables independently include properties of each of the number of target objects;
performing a cluster analysis on the number of variables for each of the number of target objects to group the number of target objects into clusters of target objects with similar variables;
determining a number of optimal clusters; and
selecting a representative target object from each optimal cluster of target objects to form a test set of target objects.

18. The medium of claim 17, where the experimentation includes high throughput research.

19. The medium of claim 17, where the test set of target objects is about 25 to about 60 percent smaller than the number of variables for each of the number of target objects.

20. The medium of claim 17, where the cluster analysis is at least one of: hierarchical cluster analysis, non-hierarchical cluster analysis, a neural network, a self-organizing map, k-means clustering, and Jarvis-Patrick clustering.
